(19) United States
(12) Patent Application Publication
(10) Pub. No.: US 2001/0023918 A1
(43) Pub. Date: Sep. 27, 2001

(54) Alignment apparatus, alignment method, exposure apparatus and exposure method

(75) Inventor: Naoto Kondo, Shinagawa-ku (JP)

Correspondence Address: OLIFF & BERRIDGE, PLC, 277 S. WASHINGTON STREET, SUITE 500, ALEXANDRIA, VA, 22314, US

(73) Assignee: NIKON CORPORATION

(21) Appl. No.: 09/805,252

(22) Filed: Mar. 14, 2001

(30) Foreign Application Priority Data
Mar. 14, 2000 (JP) 2000-069722

(51) Int. Cl. G02B 27/40

(52) U.S. Cl. 250/201.2

(57) ABSTRACT

An alignment apparatus, comprising a position detection optical system which detects a position of a mark formed on a street line of a substrate and a focus detection system which detects deviation between an irradiated region and a focused surface of the position detection optical system by irradiating a detection light on a region of said street line and a different region from a region of said mark at a time and detecting a reflected light of the detection light.

### BACKGROUND OF THE INVENTION

1. Field of the Invention

The present invention relates to an alignment apparatus and alignment method for aligning a photomask and a substrate, an exposure apparatus and an exposure method for transferring by exposure an image of a pattern formed on the photomask onto the substrate via a projection optical system by using the alignment apparatus and the method in a production process of a semiconductor device, liquid crystal display device, etc., and particularly relates to an alignment apparatus and alignment method for focusing on the substrate, exposure apparatus and an exposure method using the alignment apparatus and the method.

2. Description of the Related Art

In producing semiconductor devices, liquid crystal display devices and other devices, a projection exposure of an image of a fine pattern formed on a photomask or reticle (hereinafter, these are generally referred to as reticle) by using an exposure apparatus on a substrate, such as a semiconductor wafer, glass plate, etc., onto which a photo resist or other photosensitive agent is applied thereon, is repeatedly performed. When performing projection exposure, it is necessary that a position of the substrate is accurately aligned with a position of an image of a pattern formed on the reticle. An exposure apparatus is provide with an alignment apparatus for aligning the position. The alignment apparatus is comprised of an alignment sensor for detecting a position of an alignment mark formed on the substrate and a control system for aligning the substrate based on the position of the alignment mark detected by the alignment sensor.

Due to changes in the surface conditions (a roughness degree) of the substrate to be measured in a production process of a semiconductor device, liquid crystal display device, etc., it is difficult to accurately detect the position of the substrate using one alignment sensor, so a different sensor is generally used in accordance with the surface conditions of the substrate. Concerning the alignment sensor, generally, there are a laser step alignment (LSA) type, a field image alignment (FIA) type and laser interferometric alignment (LIA) type. Below, an explanation will be made by giving an outline of the alignment sensors.

An LSA type alignment sensor emits a laser light on an alignment mark formed on the substrate, uses a diffracted and dispersed light for measuring a position of the alignment mark, and is widely use in semiconductor wafers of a variety of conventional production processes. An FIA type alignment sensor emits the alignment mark by using a light source having a broad wavelength bandwidth, such as a halogen lamp, etc., performs image processing on an image of the alignment mark obtained thereby for measuring the position, and is effective when measuring an asymmetric mark formed on an aluminum layer or substrate surface. An LIA type aliment sensor emits laser lights having a slightly different frequency fry two directions on the alignment mark in a diffraction grating shape formed on the substrate surface, makes the two diffracted lights generated thereby interfere with each other and detects position information of the alignment mark from a phase of the interfering lights. The LIA type alignment sensor is effective when used for an alignment mark having a low step difference and a substrate having a rather rough surface.

Also generally, an optical system is provided with an auto-focusing mechanism, while the alignment sensors are also provided with an auto-focusing mechanism for making a surface to be measured within a predetermined range from the alignment sensor (this is also referred to as “focusing”). The auto-focusing mechanism is comprised of an auto-focusing sensor for emitting a beam of light for detecting the alignment mark to be measured and detecting a position (focal position) of the surface to be measured in an optical axis direction from the reflected light and a drive mechanism for setting the focal position to be in a position desired in advance.

Next, an alignment sensor of the related art will be explained. FIG. 10 is a view of the configuration of an alignment sensor of the related art. In FIG. 10, an illumination light IL10 from an illumination light source, such as an external halogen lamp, etc. is introduced into an alignment sensor 100 via an optical fiber 101. The illumination light IL10 is emitted on a field division stop 103 via a condenser lens 102. FIG. 11a is a view of an example of the field division stop 103. As shown in the figure, the field division stop 103 is formed with a mark illuminating stop 200 made by an opening in a wide rectangular shape at the center and focus detection slits 201 and 202 composed of a pair of openings in a narrow rectangular shape arranged so as to sandwich the mark illumination stop 200.

The illumination light IL10 is divided by the field division stop 103 into a first beam of light of mark illumination for illuminating an alignment mark region on a substrate w and a second beam of light of focal position detection prior to alignment. The illumination light IL20 subjected to field dividing as it passes through a lens system 104, is reflected on a half mirror 105 and a mirror 106, is reflected on a prism mirror 108 via an object lens 107, and is emitted on and near the mark region including the alignment mark AM formed within a street line SL on the substrate W as shown in FIGS. 12a and 12b. Note that the street line is a region for dividing devices formed on the wafer or for sectionalizing the wafer surface into regions (circuit pattern regions), and a circuit pattern is not formed thereon. FIGS. 12a and 12b are views for explaining the illumination region on the wafer W of the alignment sensor 100 of the related art.

A reflected light on an exposure surface of the substrate W at the time of emitting the illumination light IL20 is reflected on the prism mirror 108, passes through the object lens 107, reflected on the mirror 106, then passes through the half mirror 105. Then, it reaches a beam splitter 110 via the lens system 109 and the reflected light is diverged into two directions. A first diverged light which passed through the beam splitter 110 forms an image of the alignment mark AM on an index plate 111. Then, a light from the image and the index mark on the index plate 111 is emitted on an image pickup device 112 comprised of a two-dimensional CCD, and images of the mark AM and index mark are for on a light receiving surface of the image pickup device 112.

On the other hand, a second diverged light reflected on the beam splitter 110 irradiates on a shield plate 113. FIG. 11b is a view of an exile of the shield plate 113. The shield plate 113 shown in FIG. 11b blocks an incident light to a rectangular region added a reference number 205 and lets an incident light to a region 206 other than the rectangular region 205 pass through it. Accordingly, the shield plate 113 blocks the diverged light corresponding to the first beam of light and lets the diverged light corresponding to the second beam of light pass through it. The diverged light passed through the shield plate 113 is emitted on a line sensor 115 comprised of a one-dimensional CCD in a state that telecentric characteristics is broken by a pupil division mirror 114, and an image of the focus detection slits 201 and 202 is formed on a light receiving surface of the line sensor 115.

Here, since telecentric properties are secured between the substrate W and the image pickup device 112 when the substrate W displaces in a direction in parallel with optical axises of the illumination light and reflection light, an image of the alignment mark AM formed on the light receiving surface of the image pickup device 112 becomes defocused because the position on the light receiving surface of the image pickup device 112 does not change. On the contrary, since the reflected light to be emitted to the line sensor 115 breaks the telecentric properties as explained above when the substrate W displaces in the direction parallel with the optical arises of the illumination light and reflection light, images of the focus detection slits 201 and 202 formed on the light receiving surface of the line sensor 115 are misaligned in the crossing direction with respect to the optical axis of the diverged light. By using the characteristics, the positions (focal position) of the substrate W in the direction of the optical axes of the illumination light and the reflected light are detected by measuring the amount of deviation with respect to a reference position of the image on the line sensor 115. Details of the technique are found by referring to, for example, the Japanese Laid-Open Patent Application No. 7-321030.

When taking an example of production of a semiconductor device, a process known as the 0.25 μm rule is currently in practice, however, ends for a finer rule have become stronger and in the future central processing units (CPU) and a rand access memory (RAM) are planned to be produced using a 0.1 μm rule. Under such circumstances, further improvement in alignment accuracy is required. Generally, of necessary resolution about ⅓ is required as alignment accuracy, so an alignment accuracy of about 30 nm will be required for a resolution of 0.1 μm.

In the above alignment apparatus of the related art, from the structural limits of the optical system, as shown in FIG. 12a, an image of the mark illumination stop 200 formed on the field division stop 103 is emitted on the substrate W as an image 210, and images of focus detection slits 201 and 202 are projected on the substrate W as images 211 and 212, respectively. Note that FIG. 12b is a sectional view along the line A-A in FIG. 12a wherein reference numbers R1, R2 and R3 indicate regions on which images 210, 211 and 212 are irradiated, respectively. When processing on the substrate W is performed many times, a step difference between a device portion DP being formed on a circuit pattern and the street line SL becomes large. Namely, a large step difference arises between the position of a height of a surface of the device portion DP and a position of a height of a surface of the street line SL. This is because processing to form an insulation film, etc. is performed on the device portion DP and the processing is not performed on the street line SL.

In this case, the focal position of the alignment optical system detected by the detection operation of the focal position is not an optimal focal position with respect to the alignment mark AM but an optimal focal position with respect to the device portion DP. Therefore, when performing alignment, if the substrate W is aligned based on the focal position of the above detected alignment optical system, the alignment mark AM comes to a state of being offset by an amount of step difference between the street line SL surface and the device portion DP surface. As a result, an image of the alignment mark AM is formed in a state defocused exactly by the offset amount on the image pickup device 112, so that there is a disadvantage whereby accurate alignment is difficult to attain.

Also, since the surface of the device portion DP is uneven due to a circuit pattern formed thereon, it is considered that irradiated images of the slits 201 and 202 for focus detection are diffracted and a reflected light amount is reduced, consequently, detection of the focal position becomes difficult due to an insufficient light amount. To solve the disadvantage, it is considered, for example, to use a halogen lamp which emits a non-photosensitive light having a broad wavelength bandwidth and to divide the light emitted from the light source to a light in a range of visible light rays and an infrared rays for irradiating on the alignment mark AM. In this case, even by setting up an optical system so that the lights of the respective wavelength bandwidth are irradiated on the overall alignment mark AM, the respective wavelength bandwidth can be separated at the detection step, so that it is considered that the above disadvantage does not arise.

However, when generating a light source for mark illumination and a light source for position detection by dividing the wavelength bandwidth of the halogen lamp as explained above, wavelength bandwidth of the respective light sources are narrowed and a light having the whole wavelength bandwidth of the halogen lamp cannot be used. As a result, a light amount for detecting the alignment mark AM and a light amount for detecting the position are both reduced and it is considered that detection of the position detection of the aliment mark and detection of the focal position becomes difficult due to the insufficient light amount. Also, there may be a case where reflection characteristics of the street line SL formed on the substrate W have wavelength dependency caused by a material, etc. In this case, the reflectance is widely reduced in one bandwidth or both bandwidth of the divided lights having a narrow wavelength bandwidth, and the light amount may become disadvantageously insufficient in the same way as explained above.

Furthermore, since the optical system is set so that the lights of the respective bandwidth irradiates on the overall alignment mark AM, the light having the bandwidth for position detection is diffracted due to the alignment mark AM so that the reflectance of the light of this bandwidth may be reduced in some cases. To overcome this disadvantage, as shown in FIG. 13, the optical system may be changed to widen the irradiation region of the light of a bandwidth for position detection along the street line SL so that the region R5 in the figure is irradiated.

FIG. 13 is a view for explaining disadvantages when the illumination region is changed in the alignment sensor of the related art, In this case, there arises no disadvantage when the street line SL is formed in the direction along with the irradiation region, that is, when measuring the alignment marks AM1 and AM3. However, since the street line SL is generally formed to be orating, there arises a disadvantage that the focal position detection cannot be performed accurately when measuring the alignment marks AM2 and AM4 in the figure.

### SUMMARY OF THE INVENTION

An object of the present invention is to enable alignment of a substrate and detection of a focal position of an alignment optical system prior to the alignment with high accuracy.

According to a first aspect of the present invention, there is provided an alignment apparatus, comprising a position detection optical system which detects a position of a mark formed on a street line of a substrate, and a focus detection system which detects deviation between an irradiated region and a focused surface of the position detection optical system by irradiating a detection light on a region of said street line and a different region from a region of said mark at a time and detecting a reflected light of the detection light.

Since deviation of a street line with respect to the focused surface is detected by illuminating a detection light on the street line, deviation of a position of the street line with respect to a focus of the position detection optical system can be accurately detected. Also, the detection light is emitted on a region on the street line different from the region on which a mark is formed and not dispersed by the mark, so that a sufficient light amount for focus detection is obtained. As a result, accuracy of position detection can be improved.

The alignment apparatus of the present invention, when said street line exists in a first direction and in a second direction perpendicularly crossing with the first direction, said focus detection system preferably comprises a first detection system using a first detection light extending along with said first direction and a second detection system using a second detection light extending along with said second direction.

Even if the mark is formed on perpendicularly crossing street lines, it is preferable for detecting a mark position because the first detection light or the second detection light can be emitted on the street lines.

In this case, a plurality of at least one of the first detection light or the second detection light may be provided. If at least one of the first detection light or the second detection light is provided so as to detect a plurality of portions on the street line, it is possible to detect deviation of focus position at a plurality of portions on the substrate by one-time deviation detection, thus, accurate detection can be attained based on the detection results of the plurality of portions.

In an alignment apparatus of the present invention, said focus detection system makes a comparison of intensities of reflection lights of said first and second detection lights, and performs focus detection by using either one of said first or second detection system in accordance with the comparison result, and said focus detection system can perform focus detection by selecting and using said first detection system when a street line on which a mark for position detection exists is along said first direction, and selecting and using said second detection system when the street line is along said second direction. By doing so, it is not necessary to perform focus detection using a reflection light of a detection light irradiated on a region other than the street lines, consequently, it contributes to an improvement of throughput,

According to a second aspect of the present invention, there is provided an exposure apparatus provided with the above alignment apparatus. According to the invention, deviation of the street lines with respect to the focused surface of the alignment apparatus is detected with high accuracy by the above alignment apparatus, and alignment of the substrate can be performed with high accuracy based on the highly accurate detection results. Thus, it is extremely preferably for producing a finer device.

According to a third aspect of the present invention, there is provided an alignment method for aligning a substrate on which a mark is formed on a street line, including the steps of irradiating a detection light on a region on said street line and a region different from a region of said mark at a time, detecting deviation between an irradiated region and a focused surface of said position detection optical system by detecting a reflected light of the detection light, and then detecting a position of the mark for aligning said substrate.

In an alignment method of the present invention, when the street lines exist in the first direction and in the second direction perpendicularly crossing with the first direction, a first detection light extended along with the first direction and a second detection light extended along with the second direction can be emitted as the above detection light. At this time, it is preferable to compare intensities of reflected lights of the first and second detection lights to detect focus by using either one of the first or second detection light in accordance with the comparison result, and to perform position detection by using the first detection light when the street line on which a mark for position detection exists is along with the first direction, while using the second detection light when it is along with the second direction. According to the alignment method of the present invention, the same effects can be obtained as in the alignment apparatus of the present invention.

According to a fourth aspect of the present invention, there is provided an exposure method of aligning a photosensitive substrate as an object to be exposed by using the above alignment method and exposing the aligned photosensitive substrate via a mask on which a pattern is formed. According to the invention, the same effects can be obtained as in the exposure apparatus of the present invention as explained above.

### BRIEF DESCRIPTION OF THE DRAWINGS

These and other objects and features of the present invention will become clearer from the following description of the preferred embodiments given with reference to the attached drawings, in which:

FIG. 1 is a view of the schematic configuration of an exposure apparatus according to an embodiment of the present invention;

FIG. 2 is a view of the configuration of an alignment sensor according to an embodiment of the present invention;

FIG. 3 is a sectional view of an example of a field stop plate according to an embodiment of the present invention;

FIG. 4 is a view for explaining an illumination position of an illumination light on a wafer according to an embodiment of the present invention;

FIG. 5 is a view for explaining an irradiation position of an illumination light on a wafer on which street lines are formed according to an embodiment of the present invention;

FIG. 6 is a view of the configuration of an alignment apparatus according to another embodiment of the present invention;

FIG. 7a is a sectional view of an example of a field stop plate according to other embodiment of the present invention;

FIG. 7b is a sectional view of an example of a shield plate according to another embodiment of the present invention;

FIG. 8 is a view of a state an illumination light irradiates on an alignment mark in FIG. 5;

FIG. 9 is a flow chart of production of a device (a semiconductor chip, such as an IC and LSI, liquid crystal panel, CCD, thin film magnetic head, micro machine, etc.) using an exposure apparatus according to an embodiment of the present invention;

FIG. 10 is a view of the configuration of an alignment sensor of the related art;

FIG. 11a is a view of an example of a field division stop of the related art;

FIG. 11b is a view of an example of a shield plate of the related art;

FIG. 12a is a view for explaining an illumination region on a wafer of an aliment sensor of the related art;

FIG. 12b is a sectional view along the line A-A of FIG. 12a;

FIG. 13 is a view for explaining disadvantages when an illumination region is changed in an alignment sensor of the related art;

FIG. 14a to FIG. 14c are views of examples of performing position detection of a mark by moving a substrate stage after detecting a focus according to an embodiment of the present invention; and

FIG. 15a to FIG. 15c are views of examples of performing position detection of a mark by moving a substrate stage after detecting a focus in the case of LSA according to an embodiment of the present invention.

### DESCRIPTION OF THE PREFERRED EMBODIMENTS

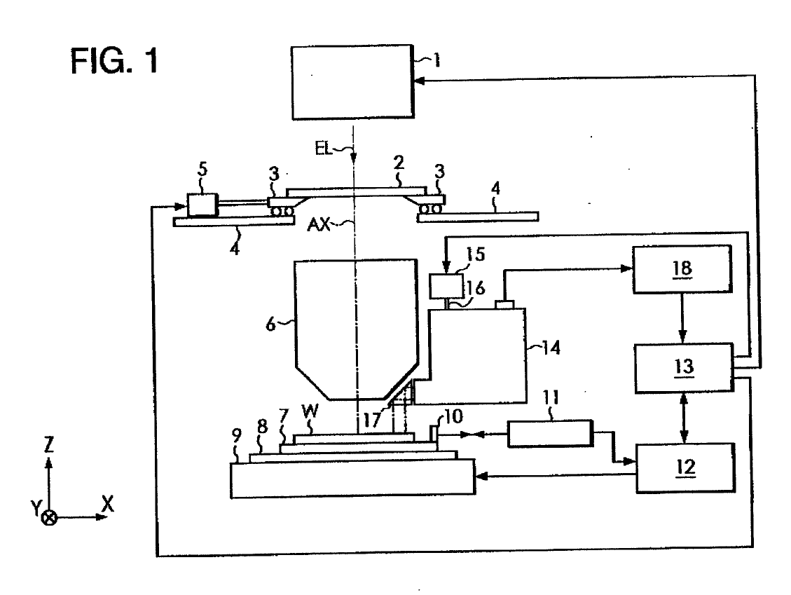

Below, an alignment apparatus, alignment method, exposure apparatus and exposure method according to an embodiment of the present invention will be explained in detail with reference to drawings. FIG. 1 is a view of the schematic configuration of an exposure apparatus according to an embodiment of the present invention. In the present embodiment, the present invention is applied to an exposure apparatus of a step-and-repeat type (collective exposure type) provided with an alignment sensor of an off-axis type. Note that the present invention can be also applied to an exposure apparatus of a step-and-scan type (scanning exposure type) exposure apparatus. In the explanation below, an XYZ rectangular coordinates system shown in FIG. 1 is set and positional relationships of respective components will be explained with reference to the XYZ rectangular coordinates system. The XYZ rectangular coordinates system is set so that the X-axis and the Z-axis are in parallel with the paper surface and the Y-axis is vertical with respect to the paper surface. In the XYZ coordinates system in the figure, actually the XY plane is set as a plane in parallel with a horizontal plane, and the Z-axis is set in the upward vertical direction.

In FIG. 1, the illumination optical system 1 emits an exposure light EL having an almost uniform intensity of illumination and irradiates the reticle 2 when a control signal instructing to emit an exposure light is output from a later explained main control system 13, An optical axis of the exposure light EL is set to be in parallel with the Z-axis direction. As the exposure light EL, for example, a g-ray (436 nm), i-ray (365 nm), KrF excimer laser (248 nm), ArF excimer laser (193 nm) and F₂ laser (157 nm) can be used.

The reticle 2 has a fine pattern to be transferred onto the wafer (substrate) W applied a photo resist thereon and hold on a reticle holder 3. The reticle holder 3 is held so as to be able to move and to finely rotate within the XY plane on a base 4. The main control system 13 for controlling operations of the whole apparatus controls operations of reticle stage 3 via a drive apparatus 5 on the base 4 for setting a position of the reticle.

When the exposure light EL is emitted from the illumination optical system 1, a pattern image of the reticle 2 is projected on respective regions as device portions on the wafer W via the projection optical system 6. The projection optical system 6 comprises a plurality of optical elements, such as lenses. Materials of the optical element is selected from optical materials, such as quartz, fluorite, etc. in accordance with wavelength of the exposure light EL. The wafer W is mounted on a Z-stage 8 via a wafer holder 7. The Z-stage 8 is a stage for finely adjusting the position of the wafer W in the Z-axis direction. The Z-stage 8 is also counted on an XY-stage 9. The XY-stage 9 is a stage for moving the wafer W to the XY-plane. Note that, while not illustrated, a stage for making the wafer W finely rotate on the XY-plane and a stage for adjusting an inclination of the wafer W with respect to the XY-plane by changing an angle with respect to the Z-axis may be provided.

On one end of an upper surface of the wafer holder 7 is attached an L-shaped moving mirror 10, and a laser interferometer 11 is arranged at a position facing a mirror surface of the moving mirror 10. While the illustration is simplified in FIG. 1, the moving mirror 10 is comprised of a plane mirror having a mirror surface vertical to the X-axis and a plane mirror having a mirror surface vertical to the Y-axis. The laser interferometer 11 is comprised of two laser interferometers for the X-axis for irradiating a laser beam on the moving mirror along with the X-axis and a laser interferometer for the Y-axis for irradiating a laser beam on the moving mirror 10 along the Y-axis. The X-coordinate and Y-coordinate of the wafer holder 7 are measured by one laser interferometer for the X-axis and one laser interferometer for the Y-axis.

Also, a rotation angle on the XY-plane of the wafer holder 7 is measured from a difference of the measurement values by the two laser interferometers for the X-axis. Information about the X-coordinate and Y-coordinate measured by the laser interferometer 11 and the rotation angle is supplied to the stage drive system 12. The information is output as position information from the stage drive system 12 to the main control system 13. The main control system 13 controls the alignment operation of the wafer holder 7 via the stage drive system 12 while monitoring the supplied position information. Note that, while not illustrated in FIG. 1, the reticle holder 3 is also provided with those similar to the moving mirror and laser interferometer provided in the wafer holder 7, and information on the XYZ position, etc. of the reticle holder 3 is input to the main control system 13.

An off-axis alignment sensor (focus optical system) 14 is provided beside the projection optical system 6. The alignment sensor 14 is an alignment apparatus according to an embodiment of the present invention provided in an exposure apparatus according to an embodiment of the present invention and is an alignment apparatus of when applied to the field image alignment (FIA) type. The alignment sensor 14 is for detecting deviation of focus position of a street line formed on the wafer W with a focus of an alignment optical system of the alignment sensor 14. The alignment sensor 14 is irradiated by an irradiation light for illuminating the wafer W from a halogen lamp 15 via an optical fiber 16. The reason why the halogen lamp 15 is use as a light source here is that an emission light of the halogen lamp 15 has a wavelength range of 500 nm to 800 nm preferably 530 nm to 800 nm, which is not a photosensitive range for the photo resist applied on the upper surface of the wafer W, and has a broad wavelength bandwidth, which can reduce effects of wavelength characteristics of the reflectance on the wafer W surface.

The illumination light emitted from the alignment sensor 14 is reflected on the prism mirror 17 and irradiates the upper surface of the wafer W. The alignment sensor 14 takes in the reflected light of the upper surface of the wafer W via the prism mirror 17, converts detection results to an electric signal and outputs to an alignment signal processing system 18. Also, while illustration is omitted, a position detection sensor (position detection optical system) for detecting a position on the XY-plane of the alignment mark AM formed on the wafer W is provided and detection results of the position detection sensor are input into the alignment signal processing system 18. A focal position of the position detection sensor in the Z-axis direction is set to be identical with that of the alignment sensor 14 in the Z-axis direction. The alignment signal processing system 18 obtains position deviation (defocused amount) about the street line SL formed on the wafer W with respect to the focal position of the alignment sensor and a position of the alignment mark AM on the XY-plane based on the detection results from the alignment sensor 14 and the detection results output from the position detection sensor and outputs the same as wafer position information to the main control system 13.

The main control system 13 controls the whole operations of the exposure apparatus based an the position information output from the stage drive system 12 and the wafer position information output from the alignment signal processing system 18. Specifically, the main control system 13 outputs a drive control signal to the drive system 12 based on the wafer position information output from the aliment signal processing system 18. The drive system 12 performs stepping drive on the XY-stage 9 and Z-stage 8 based on the drive control signal. At this time, the main control system 13 first outputs a drive control signal to the drive system 12 so that a position of a reference mark formed on the wafer W is detected by the position detection sensor. When the drive system 12 drives the XY-stage 9, detection results by the alignment sensor 14 and position detection sensor are output to the alignment signal processing system 18. From the detection results, for example, a base line amount as an amount of deviation between a detected sensor by the position detection sensor and a center of the projected image of the reticle R (an optical axis AX of the projection optical system 6) is measured. Then, by controlling the X-coordinate and Y-coordinate of the wafer W based on a value obtained by adding the above base line amount to the position of the alignment mark AM measured by the position detection sensor, the respective shot regions are to be accurately aligned with exposure positions.

In the present embodiment, controlling alignment of the position of the street line SL formed on the wafer W to the focal position of the alignment sensor 14 is performed so as to improve detection accuracy of the alignment mark AM position. Namely, when measuring the position of the alignment mark AM on the XY-plane, the main control system 13 controls the stage drive system 12 so that the alignment mark AM is within the range detected by the position detection sensor first, and then, controls the stage drive system 12 so that the position of the street line SL formed on the wafer W in the Z-axis direction is focused at the focal position of the alignment sensor 14. As explained above, since focal positions of the position detection sensor and alignment sensor 14 in the Z-axis direction are set to be identical, by focusing the street line formed on the wafer W on the focal position of the alignment sensor 14, the street line SL is to be focused also on the position detection sensor. Accordingly, by improving accuracy of focal position detection of the alignment sensor 14, it is possible to align the alignment mark AM with the focus of the position detection sensor, consequently, detection accuracy of the alignment mark AM by the position detection sensor is improved. After detecting the position of the alignment mark AM and accurately aligning the shot region to be exposed with the exposure position, the main control system 13 outputs a control signal to the illumination optical system 1 to emit an exposure light EL.

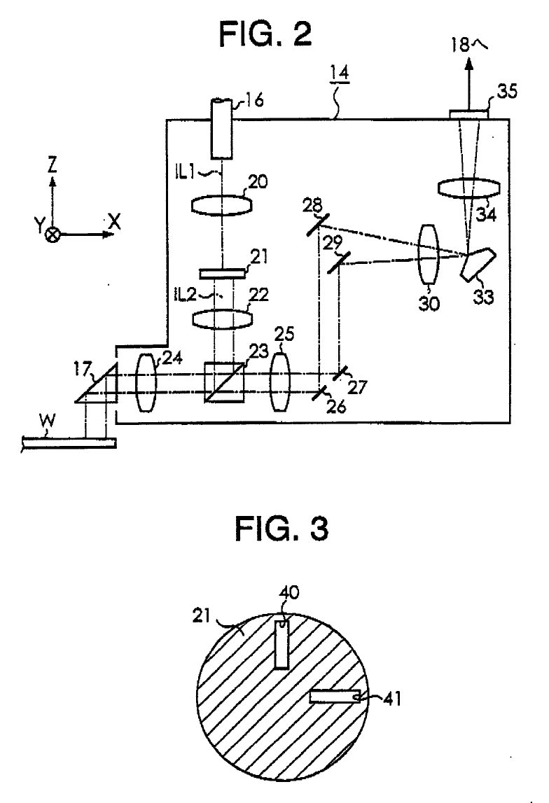

The schematic configuration and operations of an exposure apparatus according to an embodiment of the present invention were explained above. Next, an alignment sensor 14 provided in the alignment apparatus according to an embodiment of the present invention will be explained in detail. FIG. 2 is a view of the configuration of the alignment sensor according to an embodiment of the present invention. Note that in rig. 2, the same reference numbers are used for identical components with those shown in FIG. 1. As shown in FIG. 2, the alignment sensor 14 is introduced as an illumination light IL1 having a wavelength range of 500 nm to 800 nm preferably 530 nm to 800 nm from the halogen lamp 15 in FIG. 1 via an optical fiber 16.

The illumination light IL1 irradiates on a field stop plate 21 via a condenser lens. The field stop plate 21 is used to regulate a shape of an image of the illumination light IL irradiated on the wafer W. FIG. 3 is a sectional view of an example of the field stop plate 21. The field stop plate 21 shown in FIG. 3 is disk shaped, on which a rectangular opening 40 is formed from near the center in the Y-axis direction, and a rectangular opening 41 from near the center in the X-axis direction is further formed. Accordingly, the incident illumination light IL on the field stop plate 21 is shaped to be an illumination light in a rectangular shape longitudinal in the X-axis direction and an illumination light in a rectangular shape longitudinal in the Y-axis direction by passing through the field stop plate 21. Below, when distinguishing these illumination lights, the one in a rectangular shape longitudinal in the X-axis direction will be referred to as illumination light IL_{X} and the one in a rectangular shape longitudinal in the Y-axis direction will be referred to as illumination light IL_{Y} in the explanation. When explaining them together without distinguishing the illumination lights ILₓ an IL_{Y}, the explanation will be made by referring that an illumination light IL2.

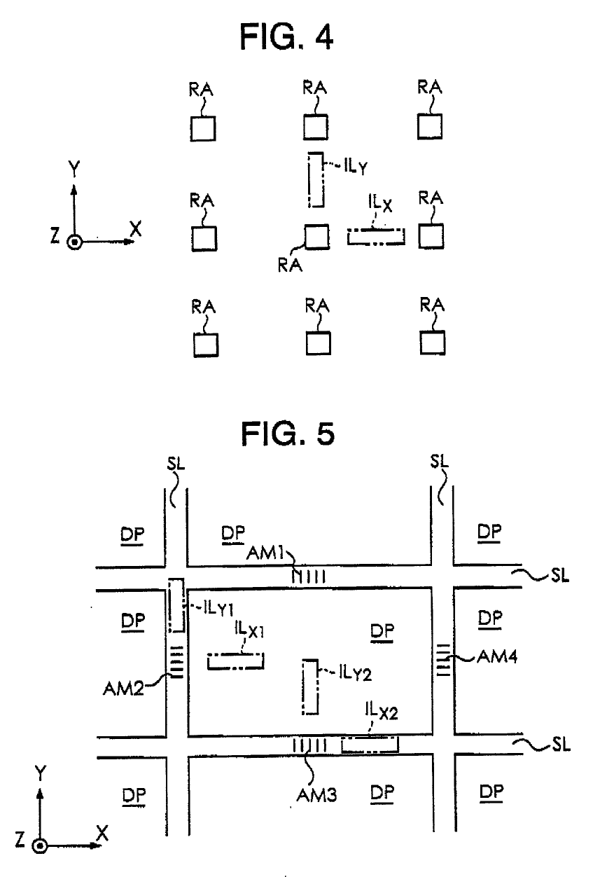

After passing through a lens system 22, the illumination light IL2 is reflected on a beam splitter 22, passes through an object lens 24 and is emitted from the alignment sensor 14. When the illumination light IL2 is emitted from the alignment sensor 14, it is reflected by a prism mirror 17 and illuminates near an alignment mark AM formed on a wafer W. FIG. 4 is a view for explaining the irradiation position of the illumination light IL2 on the wafer W. In FIG. 4, the regions indicated by a code RA are regions on which the alignment mark AM is formed on the XY-plane. Namely, the alignment mark AM is formed within the region RA. In an ale shown in FIG. 4, the regions RA are formed at crossing positions of a plurality of straight lines in parallel with the x-axis direction and a plurality of straight lines in parallel with the Y-axis direction. The illumination light IL_{X} and illumination light IL_{Y} composing the illumination light IL2 as a detection light are illuminated on regions other than the regions RA. The illumination light IL_{X} and illumination light IL_{Y} are also illuminated on regions other than the regions RA when an arrangement of the regions RA is changed from that in FIG. 4.

Returning to FIG. 2, the wafer W is arranged so that regions, on which the alignment mark AM is fanned, become almost conjugated (image forming relationship) with the field stop plate 21 regarding a constructional system of the lens system 22 and object lens 24. Reflected lights of the illumination light IL_{X} and illumination light IL_{Y} irradiate on the beam splitter 23 via the prism mirror 17 and object lens 24. The reflected light irradiated on the beam splitter 23 passes through the beam splitter 23, irradiate on the reflection plates 26 and 27 via the lens system 25 and is reflected. Here, the reason why the reflection plates 26, 27, 29 and 29 are used for changing the proceeding direction by reflecting the reflected light passed through the lens system 25 is because a line sensor, such as a one-dimensional CCD, etc. is used as a light receiving element as will be explained later on. Namely, in order to measure the reflected light from the wafer W as a two-dimensional image by a light detection surface by using the one-dimensional line sensor, an optical system comprised of the reflection plates 26, 27, 28 and 29 is devised. The reflection plate 26 is mainly irradiated the reflected light of the illumination light IL_{X}, while the reflection plate 27 is mainly irradiated the reelected light of the illumination light IL_{Y}.

The reflected light of the reflection plate 26 and that of the reflection plate 27 irradiate on the reflection plates 28 and 29 and reflected, respectively. The reflected lights of the reflection plate 28 and 29 respectively irradiate on the lens system 30. The light passed through the lens system 30 irradiates on a pupil division mirror 33 as an optical element to break telecentric characteristics. When the light passed through the lens system 30 irradiates the pupil division mirror 33, it is reflected on the pupil division mirror 33 and the telecentric property is broken. The non-telecentric light forms an image of the reflected light of the illumination light IL_{X} and an image of the reflected light of the illumination light IL_{Y} again on the line sensor 35 cased of one-dimensional CCD, etc. via the lens system 4. Namely, images of the reflected-light of the illumination light IL_{X} (two images divided by the pupil division mirror 33) and two images of the reflected light of the illumination light IL_{Y}, thus, four images in total are formed on the line sensor 35. Note that the image by the illumination light IL_{X} and the image by the illumination light IL_{Y} are respectively formed on different positions on the sensor 35. The line sensor 35 picks up the formed image on the light receiving surface and performs photoelectric conversion. An electric signal after the photoelectric conversion is output to the alignment signal processing system 18.

In this way, the object lens 24, reflection plate 26, reflection plate 28, lens system 30, pupil division mirror 33, lens system 34 and line sensor 35 compose a first detection system of a focus detection system, while, the object lens 24, reflection plate 27, reflection plate 29, lens system 30, pupil division mirror 33, lens system 34 and line sensor 35 compose a second detection system of the focus detection system. Both of the first and second detection systems include the pupil division mirror 33 and have non-telecentric characteristics. Accordingly, when the wafer W displaces in the Z-axis direction with respect to the focal position of the alignment sensor 14, the position of the image formed again on the line sensor 35 deviates in the longitudinal direction of the line sensor 35. By utilizing this, an AF detection is performed. First, in a state that, while not shown, the reference mark of a well-known reference mark plate (fiducial mark plate) provided on the wafer holder 7 and the image forming surface of the projection optical system 6 are registered, the positions of the images of reflected lights of the illumination light IL_{X} and illumination light IL_{Y} formed again on the line sensor 35 are stored in a processing system 18 as reference positions. Note that in a state that image forming surfaces of the alignment mark AM and projection optical system 6 are registered by using the alignment mark AM on the wafer instead of the reference mark plate, the position of the image formed again on the line sensor 35 may be stored as a reference position in the alignment signal processing system 18 in advance. At the time of performing AF detection, in the alignment signal processing system 18, an mount of deviation in sideways of the position of the image formed on the line sensor 35 by the reflection lights of illumination light IL_{X} and illumination light IL_{X} with respect to the above stored reference position (the image positions of illumination light IL_{X} and illumination light IL_{Y} on the sensor 35 when focused) and an amount of deviation in the Z-axis direction (position deviation direction and the amount) of the alignment mark AM to be measured from the direction the sideway deviation occurred are detected.

Note that the AF detection method using the pupil division method is well known, for example, in the Japanese Laid-Open Patent Publication Nos. 6-214150 and 10-223517, so a further explanation will be omitted here.

Outline of the positional relationship of the illumination light IL_{X} and illumination light 14 with regions RA on which an alignment mark AM is formed was explained by using FIG. 4. Next, irradiation positions of the illumination light IL_{X} and illumination light IL_{Y} on an actual wafer W will be explained. FIG. 5 is a view for explaining the irradiation position of the illumination light IL2 on the wafer W on which street lines are formed. As shown in FIG. 5, an actual wafer W is formed a device portion DP for attaching an electronic circuit, a plurality of street lines SL arranged between the device portions DP and perpendicularly crossing to each other, and alignment marks AM1 to AM4 arranged on the street lines, etc.

Now, when detecting a position of the alignment mark AM2 (an alignment mark for position detection in the Y-direction) using the position detection sensor, an illumination light IL_{Y1} is emitted on the street lines SL. When irradiating the illumination light IL_{Y1} on the street lines SL, the illumination light IL_{X1} is made to emit on the device portions DP as shown in FIG. 5. When detecting a position of the alignment mark AM3 (an alignment mark for position detection in the X-direction) using the position detection sensor, an illumination light IL_{Y2} is emitted on the street lines SL. When emitting the illumination light IL_{Y2} on the street lines SL, the illumination light IL_{Y2} is made to emit on the device portions DP this time. When detecting a position of the alignment mark AM2 in the figure, reflected lights of both of the illumination light IL_{X1} and illumination light IL_{Y1} are detected by the alignment sensor 14, while when detecting a position of the alignment mark AM3, reflected lights of both of the illumination light IL_{X2} and illumination light IL_{Y2} are detected by the alignment sensor 14.

Note that an explanation was made in a case where the direction in which the street lines exist (extend) and the measurement direction of the alignment marks formed on the street lines are made to be the same in FIG. 5, but the present invention is not limited to this and, for example, the alignment mark AM3 for measuring an X-direction position may be formed on a street line on which the mark AM2 is formed. In this case, the mark AM3 is measured the mark position by irradiating the illumination light IL_{Y}.

Detection results of reflected lights of the illumination light IL_{X1} and illumination light IL_{Y2} irradiated on the device portions DP are not necessary for highly accurate position detection of the alignment marks AM2 and AM3. The alignment marks AM1 and AM3 in FIG. 5 are alignment marks for position detection in the X-direction, and alignment mark AM2 and AM4 are for position detection in the Y-direction. Since it is possible to judge the alignment mark for position measurement of which direction by a signal output from the position detection sensor, the alignment signal processing system 118 is set so as not to perform processing on detection results of a reflection light of an illumination light in different direction from position measurement for omitting unnecessary processing. Also, by storing in the main control system 13 information indicating the position of the alignment marks AM and for which direction the position measurement is to be made by the alignment marks AM formed at the position, and outputting the information to the alignment signal processing system 18 every time an alignment mark AM is measured, unnecessary signal processing can be omitted without using output from the position detection sensor.

It is also considered that the reflection lights of the illumination light IL_{X1} and illumination light IL_{Y2} irradiating on the device portions DP have less intensity than that of the illumination light IL_{Y1} and illumination light IL_{X2} irradiating on the street lines SL due to diffraction caused by circuits formed on the device portions DP. Accordingly, the alignment signal processing system 18 may be made to compare the signal intensities of the detection results of the reflection lights of the illumination light IL_{X1} and that of illumination light IL_{Y1} and to perform processing only on the detection results having a higher intensity.

Operations of position detection using the alignment sensor 14 of an exposure apparatus of the present embodiment will be explained next.

When the processing starts, the main control system 13 drives the XY stage 9 so that the alignment mark AM on the wafer W moves to a position corresponding to a detection region of the alignment sensor 14. The main control system 13 outputs a control signal to the halogen lamp 15 to let it emit illumination light IL1. When the illumination light IL1 is emitted, it is introduced into the alignment sensor 14 via the optical fiber 16, passes through the condenser lens 20, is shaped by the field stop plate 21 and becomes an illumination light IL2 composed of an illumination light IL_{X} and illumination light IL_{Y}. The illumination light IL2 passes through the lens system 22, is reflected by the beam splitter 23, passes through the object lens 24, is reflected by a prism mirror 17 and the illumination light IL_{X} and illumination light IL_{Y} are irradiated on the wafer W.

The reflected light of the illumination light IL_{X} and illumination light IL_{Y} returns to the alignment sensor 14 via the prism mirror 17, successively passes through the object lens 24, beam splitter 23 and lens system 25. The reflected light of the illumination light IL_{X} is successively reflected by the reflection plates 26, 28, 31 and 32 and irradiates the lens system 30, while the reflection light of the illumination light IL_{Y} is successively reflected by the reflection plates 27 and 29 and irradiates the lens system 30. Images at the time of irradiating the lens system 30 are that the longitudinal directions are mutually in parallel. Then, it is received by the line sensor 35 in a state that the telecentric characteristics are broken via the pupil division mirror 33. On the light receiving surface of the line sensor, these images are formed in a state deviated in sideways in accordance with the position of the Z-axis direction of the alignment mark AM.

An electric signal subjected to photoelectric converting by the line sensor 35 is input to the alignment signal processing system 18 and subjected to signal processing. At this time, the alignment signal processing system 18 does not perform processing on the detection results of the reflection light of the illumination light IL_{Y1} and that of the illumination light IL_{Y2} irradiating the device portions DP shown in FIG. 5 in accordance with the position detection direction of the alignment mark AM. An optimal focus position of the street lines SL formed on the wafer W with respect to the focal position of the alignment sensor 14 is detected from the deviation amount sideways of a detection signal with respect to the reference position stored in the alignment signal processing system 19 in advance. The main control system 13 drives the Z-stage a via the stage drive system 12 so that the position of the street lines SL on the wafer W in the Z-axis direction registers with the optimal focal position. When moving of the Z-stage 8 is completed, an X-coordinate and Y-coordinate of the alignment mark AM are detected with high accuracy by the position detection sensor.

The main control system 13 performs correction on the X-coordinate and Y-coordinate of the detected alignment mark AM by adding the above explained bass line amount. Then, the main control system 13 drives the XY-stage 9 so that the center of respective shot regions and the optical axis AX are registered based on the base line corrected X-coordinate and Y-coordinate of the wafer W via the stage drive system 12. As a result, accurate registration of the respective shot regions on the wafer W to the exposure positions, that is, an accurate alignment of the wafer W is performed

According to an embodiment of the present invention explained above, the following effects can be obtained.

First, since an illumination light emitted from the halogen lamp 15 is irradiated on a region on the street line SL and on which an alignment mark AM is not formed at a time, and the reflection light is used for detecting position deviation in the Z-axis direction of the wafer W with respect to the focal position of the alignment sensor 14, the focal position of the position detection sensor can be aligned on the street line SL being formed the alignment mark AM and not on the device portion DP having step difference from the street line SL. Thus, highly accurate position detection of the alignment mark formed on the street line SL can be performed.

Second, since the illumination light IL1 in shaped by the field stop plate 21 to be the rectangular illumination light IL_{X} longitudinal in the X-axis direction and the rectangular illumination light IL_{Y} longitudinal in the Y-axis direction, and the illumination light IL_{X} and illumination light IL_{Y} are irradiated on the wafer W, even if the alignment mark AM is formed on the perpendicularly crossing street lines, either one of the illumination lights can be irradiated on the perpendicularly crossing street lines SL on which the alignment mark AM is formed, thus, position deviation of the street line with respect to the alignment sensor 14 can be accurately detected even in such a case. As a result, highly accurate alignment can be also performed,

Third, measurement is usually performed by recognizing in advance the extending direction of the street line on which the alignment mark to be measured is formed and recognizing whether the illumination light IL_{X} or illumination light IL_{Y} is used as a measuring light. However, even in a case where they are not recognized in advance, correct measurement can be performed. Namely, when one of the illumination light IL_{X} or illumination light IL_{Y} emits onto the street line and the other irradiates the device portion DP at the time of measuring, the intensity of the reflected light of the illumination light irradiated on the device portion DP is reduced compared with that irradiated on the street line. The alignment signal processing system 18 is configured to compare the intensities of the reflected lights of the illumination light IL_{X} and illumination light IL_{Y} and detect position deviations in the Z-axis direction of the wafer W with respect to the alignment sensor 14 by using only the detection results of the reflection light of the illumination light emitted on the street line SL (results of the one having a higher reflection light intensity of the illumination light IL_{X} and illumination light IL_{Y}). Therefore, an accurate measurement can be made by automatically judging an illumination light which should be used for the measurement. Namely, it is possible to automatically judge which reflection light of the illumination light IL_{X} and illumination light IL_{Y} should be used as detection results in accordance with the direction of position measurement of the detected alignment mark AM, furthermore unnecessary processing can be avoided.

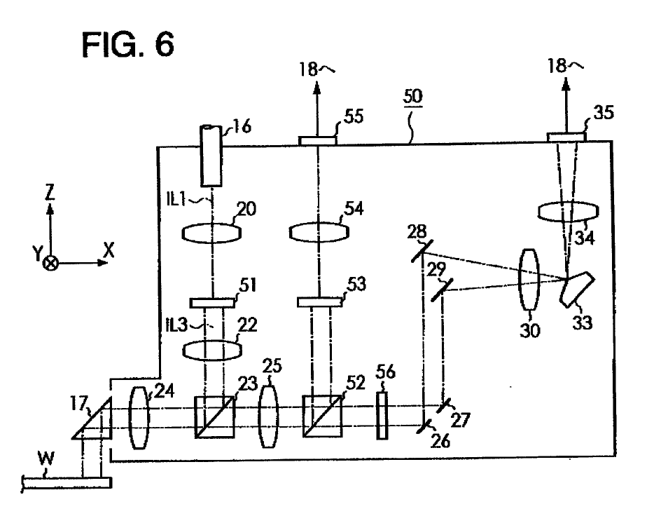

Next, an alignment apparatus according to another embodiment of the present invention will be explained. FIG. 6 is a view of the configuration of an alignment apparatus according to another embodiment of the present invention, Note that in FIG. 6, the same components as those in the alignment sensor 14 shown in FIG. 2 are indicated by the same reference numbers and the explanation will be omitted. Different points in an alignment sensor 50 provided in the alignment apparatus according to another embodiment of the present invention from the alignment sensor 14 shown in FIG. 2 are that a field stop plate 51 is provided instead of the field stop plate 21, a beam splitter S2 and a shield plate 56 are successively provided to a light path from the lens system 25 to the reflection plates 26 and 27, furthermore, an index plate 53, a relay lens system 54, and an image pickup device 55 are provided on a light path of a light reflected by the beam splitter 52. The object lens 24, lens system 25, index plate 53, relay lens system 54 and image pickup device 55 compose a position detection optical system. Accordingly, the not illustrated position detection sensor composing the position detection optical system explained on the above embodiment will be omitted in the present embodiment. Also, the position detection optical system composes a telecentric optical system.

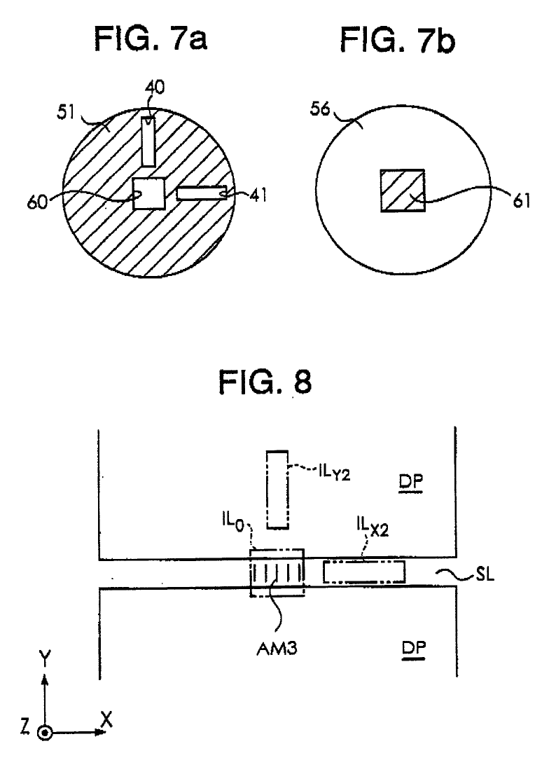

FIG. 7a is a sectional view of an example of the field stop plate 51. The field stop plate 51 is disk shaped the same as the field stop plate 21 shown in FIG. 3A, on which a rectangular opening 40 is formed from near the center in the Y-axis direction, and a rectangular opening 41 from near the center in the X-axis direction is further provided. The field stop plate 51 is further formed by an opening 60 whose section is substantially square shaped. The opening 60 is provided for emitting on the alignment mark AM. The index plate 53 is arranged conjugatedly with an exposure surface of the wafer W with respect to the constructional system of the object lens 24 and lens system 25 in a focused state and is arranged conjugatedly with the light receiving surface of the image pickup device 55. The index plate 53 is obtained by forming an index mark by means of a chrome layer, etc. on a transparent plate, wherein portions of a reflected image of the aliment mark AM pass through and are left transparent. Also, the index mark is a position reference in the direction conjugated with the X-axis direction or Y-axis direction on the wafer W.

The image pickup device 55 is comprised, for example, of a two-dimensional CCD, etc. and picks up the reflection image of the alignment mark AM formed on the light reflection surface and a projection image of the above index mark and performs photoelectric conversion, An image signal obtained by the photoelectric conversion is output to the alignment signal processing system 18, where position information in the X-axis direction and Y-axis direction as to the wafer W is obtained as an X-coordinate and Y-coordinate of the alignment mark AM based on the image signal, FIG. 7b is a view of an example of the shield plate 56. The shield plate 56 is for blocking unnecessary light except the light to be used for focal position detection, specifically, it shields a reflected light of an illumination light irradiated on the wafer W by passing through the opening 60 of the field stop plate 51 by the rectangular region 61 which shields an incident light from irradiating on the first detection system and the second detection system.

When the illumination light IL1 is irradiated in the alignment sensor 50 by the halogen lamp 15 via the optical fiber 16, it is shaped to be an illumination light IL3 comprised of an illumination light IL_{X}, illumination light IL_{Y} and illumination light IL₀ by the field stop plate 51 via the condenser lens 20. The illumination light IL3 passes through the lens system 22, is reflected by the beam splitter 23, passes through the object lens 24, is reflected by the prism mirror 17 and is projected on the wafer W. FIG. 8 is a view of a state that the illumination light IL3 irradiates the alignment mark AM3 in FIG. 5. As shown in FIG. 8, the illumination light IL_{X} and illumination light IL_{Y} are emitted on the same positions as in the case shown in FIG. 5, but in the present embodiment, the illumination light IL₀ irradiates the alignment mark AM3.

Reflection lights of the illumination light IL_{X}, illumination light IL_{Y} and illumination light IL₀ return into the alignment sensor 50 via the prism mirror 17, successively pass through the object lens 24, beam splitter 23 and lens system 25 and irradiate on the beam splitter 52. A penetrated light in the reflection light irradiated on the beam splitter 52 irradiates on the shield plate 56, by which only reflection light of the illumination light IL₀ is blocked, and the reflection lights of the illumination light IL_{X} and illumination light IL_{Y} which passed through the shield plate 56 irradiate on the reflection plate 26 or 27, pass through the light path explained with reference to FIG. 2 and are detected by the line sensor 35.

On the other hand, the light reflected by the beam splitter 52 irradiates on the index plate 53 and only reflection light of the illumination light IL₀ passes through the index plate 53. An image of the alignment mark AM that passed through the index plate and an image of the index mark on the index plate 53 are formed on the light receiving surface of the image pickup device 55 via the relay lens system 54. Since the position detection optical system composes a telecentric system, when position deviation of the wafer W occurs in the Z-axis direction from the focal position of the alignment sensor 50, the position of the image formed on the image pickup surface of the image pickup device 55 is not changed and defocused. Since focal positions of the position detection optical system and the focus measurement system in the Z-axis direction are set to be identical, by detecting position deviation of the wafer W by the focus measurement system, performing alignment by driving the Z-stage 8 using the main control system 13 via the drive system 12, and aligning the focal position of the focus measurement system to the street line SL on the wafer W, the focal position of the position detection optical system is also set to the street line SL.

According to the above explained alignment apparatus of another embodiment of the present invention, since a position detection optical system and focus measurement system for measuring the position of the alignment mark AM on the XY-plane are provided in the alignment sensor 50, the apparatus can be made compact and adjustment in the Z-axis direction of the position detection optical system and the focus measurement system is unnecessary, thus, handling is easy.

In the example shown in FIG. 8, since the aliment mark AM3 corresponds to a shot at relatively the center of the substrate and positions close to the center of the street line SL, the substrate stage (XY-stage 9) does not have to be moved after position detection by the illumination light IL_{X2} and position detection of the alignment mark AM3 by the illumination light IL₀ can be performed. But the positional relationship is not always like the one shown in FIG. 8 in all cases.

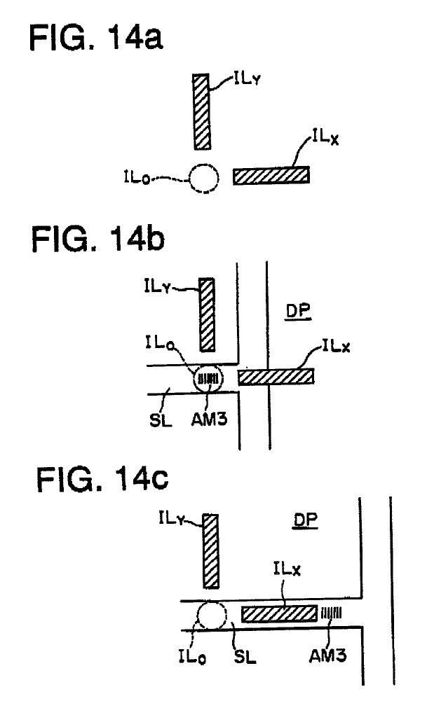

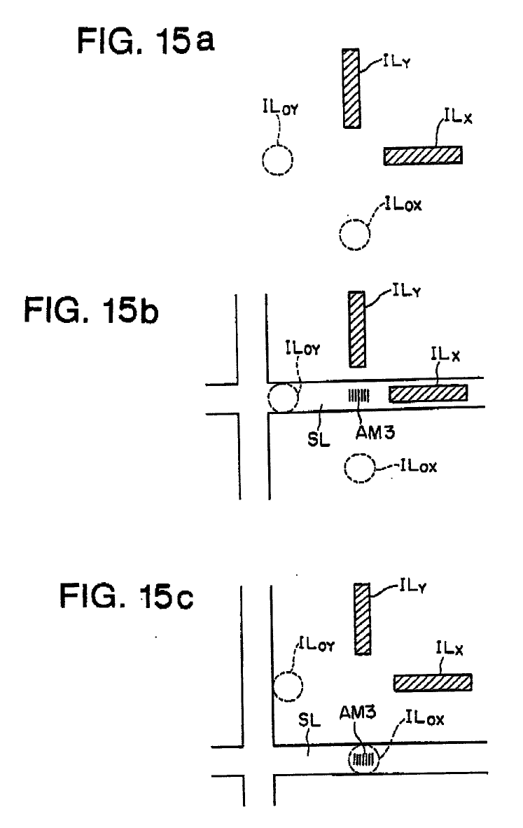

In accordance with a wafer to be measured and sensor to be used for alignment measurement, an arrangement as shown in FIG. 14b and FIG. 15b may arise in some cases.

FIGS. 14a to 14c are views of examples when a semiconductor chip is produced but not arranged in grating on the wafer. As shown in FIG. 14a, when measuring on the wafer shown in FIG. 14b in the case where an alignment AF illumination position (illumination light IL_{X}, illumination light IL_{Y}) and an alignment mark measurement position (illumination light IL₀) are defined (the same arrangement as the positional relationship shown in FIG. 8), if the alignment mark illumination light region IL₀ is aligned to the alignment mark AM3, the AF detection light illumination light IL_{X} is partially on the street line SL, but a remaining part is illuminated outside the street line (process region DP). The detection results becomes unpreferable when performing the AF detection in this state.

Thus, when in the arrangement relationship as shown in FIG. 14b, the XY-stage 9 is controlled so that all of the AF detection light IL_{X} illuminates on the street line SL and AF detection is performed, then, the stage 9 is controlled such as to enter the arrangement shown in FIG. 14b and detection of the alignment mark AM3 is performed.

FIGS. 15a to 15c are views of examples wherein an LSA is used as the alignment measurement sensor. When the measurement position of the LSA (illumination light IL_{0X} and illumination light IL_{0Y}) and the AF measurement position (illumination light IL_{X} and illumination light IL_{Y}) are configured to be in the arrangement relationship as shown in FIG. 15a, it ends up becoming an arrangement as shown in FIG. 15b when measuring the water.

Also in this case, as explained above, position controlling of the stage 9 is performed so that all of the AF detection light IL_{X} illuminates on the street line SL as shown in FIG. 15b and the AF detection is performed, then, position control of the stage 9 is performed so as to obtain the arrangement shown in FIG. 15c and detection of the alignment mark AM3 is performed.

Note that it is preferable for improvement of detection accuracy that a plurality of at least one of the first detection system and second detection system of the focus detection system in the above alignment sensor 14 or the alignment sensor 50 is provided, and that position deviation is detected from a plurality of focal positions on the street line around the mark on the wafer W at one-time focus detection. Furthermore, in the embodiment, an FIA type alignment sensor was explained as an example of the alignment Sensors 14 and 50, but the present invention can be also applied to laser step alignment (LSA) type and laser interferometric alignment (LIA) type alignment sensors. Also, in the above aliment, a shape of the illumination light IL_{X} and illumination light IL_{Y} were rectangular, but the present invention is not limited to the shape and it may be suitably changed in accordance with an object to be measured. Furthermore, when the street lines SL are formed on the wafer but are not perpendicularly crossing, an optical system or field stop plates 21 and 51 may be changed in accordance with the street line for illuminating it.

Note that the above explained exposure apparatus (FIG. 1) according to an be embodiment of the present invention is produced by electrically, mechanically or optically connecting and assailing the respective components shown in FIG. 1, such as, a reticle aliment system including an illumination optical system 1, reticle holder 3, base 4, drive apparatus 5, a wafer alignment system including a wafer holder 7, Z-stage 8, XY-stage 9, moving mirror 10 and laser interferometer 11, and a projection optical system 6, then, performing general adjustment (electric adjustment, operation confirmation, etc.) so as to be capable of performing position controlling of the wafer W accurately at a high speed, improving the throughput, and exposing at high accuracy, Note that production of the exposure apparatus is preferably performed in a clean room where the temperature, degree of cleanliness etc. are managed.

Next, production of a device wherein an exposure apparatus and exposure method of an embodiment of the present invention is used will be explained.

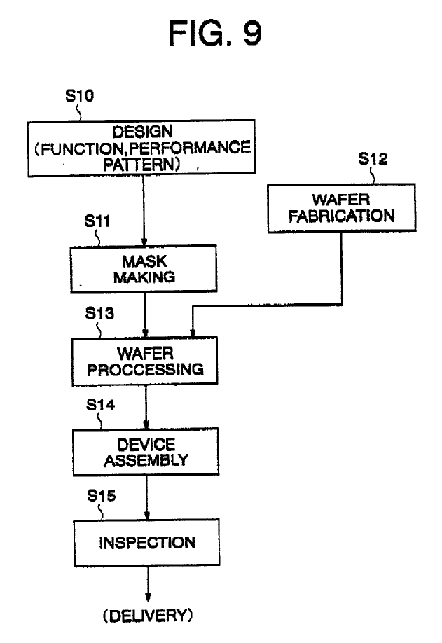

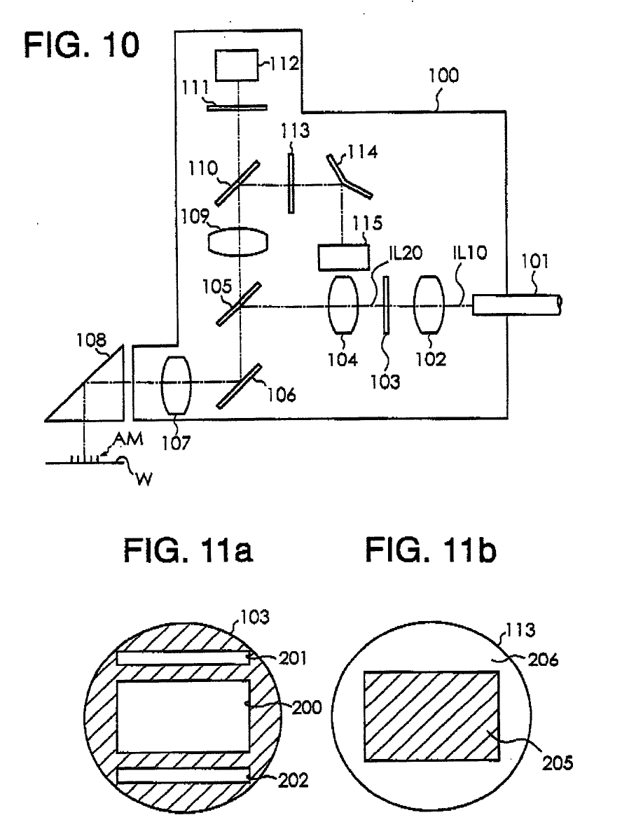

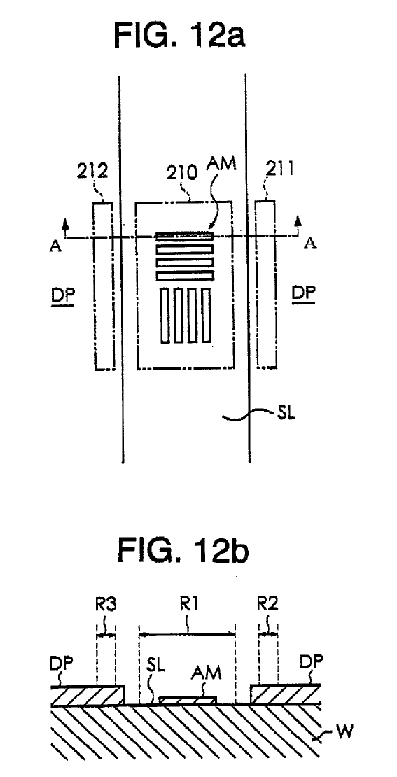

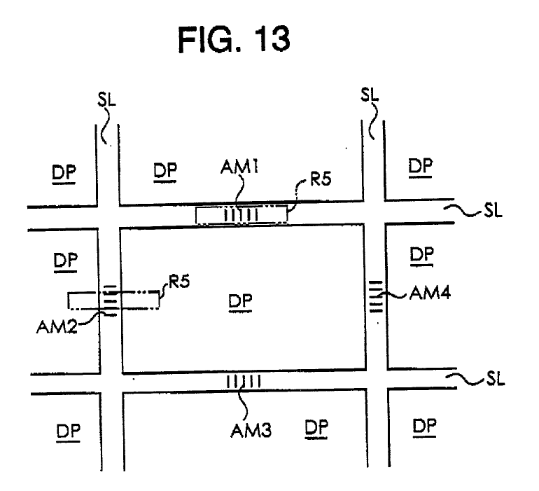

FIG. 9 is a flow chart for producing a device (an IC, LSI and other semiconductor chip, liquid crystal panel, CCD, thin film magnetic head, micro machine, etc.) by using the exposure apparatus of an embodiment of the present invention. As shown in FIG. 9, function design of a device (for example, circuit design, etc. of a semiconductor device) is performed first and pattern design for realizing the function is performed in Step S10. Continuously, a mask forming a designed circuit pattern is prepared in Step S11 (mask making step). on the other hand, a wafer is prepared by using a material, such as silicone, etc., in Step S12 (wafer fabrication step).

Next, in Step S13, an actual circuit, etc. is formed on the wafer using lithography techniques by using the mask and wafer prepared in the Steps S10 to S12. Then, in Step S14 (device assembly step), the wafer processed in the Step S13 is used for snaking a chip. The Step S14 includes an assembly process (dicing, bonding), a packaging process (chip sealing), etc. Finally, in Step S15 (inspection step), inspection of a operation confirmation test, durability test, etc. is conducted on the device produced in the Step S15. A device is completed after passing through these processes and is delivered.

Note that an exposure apparatus of the present embodiment may be applied to a scanning type exposure apparatus for exposing a mask pattern by moving the mask and substrate in synchronization. Also, use of the exposure apparatus is not limited to an exposure apparatus for semiconductor production, and may be broadly applied to, for example, an exposure apparatus for liquid crystal for transferring a liquid crystal element pattern on a four-sided glass plate, and an exposure apparatus for producing a thin film magnetic head. A light source of an exposure apparatus of the present embodiment is not limited to a g-ray (436 nm), i-ray (365 nm), KrF excimer laser (248 nm), ArF excimer laser (193 nm) and F₂ laser (157 nm), and an X-ray, electron ray and other charge particle ray may be used. For example, when using an electron ray, a lanthanum hexaboride (LaB₆) and tantalum (Ta) of a thermionic emission type can be used as an electron gun.

Magnification of the projection optical system is not limited to a reducing system, and may be equal and enlarging system. As a projection optical system, when using a far ultraviolet ray, such as an excimer laser, a material in which far ultraviolet ray passes through, such as quartz, fluorite, etc. are used, while when using an F₂ laser or X-ray, an optical system of a catadioptric system or dioptric system is used (using a dioptric type also for reticle), when using an electron ray, an electronic system comprised of an electronic lens and a polariscope may be used as an optical system. Note that it is needless to mention but a light path through which the electron ray passes is in a vacuum state.

When using a linear motor for the wafer stage and reticle stage, any air floating type using air bearings, and magnetic floating type using a Lorentz force or reactance force may be used. Also, the stage may be a type with a guide or a type without a guide. As a drive apparatus of the stage, a plane motor may be used for driving the stage using an electromagnetic force by facing a magnetic unit wherein magnets are two-dimensionally arranged toward an armature unit wherein coil is two dimensionally arranged. In this case, it is sufficient that either one of the magnetic unit or the armature unit is connected to the stage and the other is provided on the moving side of the stage.

A reaction force generated by moving the wafer stage may be mechanically released to the floor (ground) by using a frame member as described in the Japanese Laid-open Patent publication No. 8-166475. The reaction force caused by moving the reticle stage may be mechanically released to the floor (ground) by using a frame maker as described in the Japanese Laid-Open Patent Publication No. 8-330224.

Note that the embodiments explained above were descried to facilitate the understanding of the present invention and not to limit the present invention. Accordingly, elements disclosed in the above embodiments include all design modifications and equivalents belonging to the technical field of the present invention.

As explained above, according to the present invention, since deviation of the street line with respect to a focused surface is detected by illuminating a detection light on the street line, there is an effect that position deviation of the street line with respect to a focus of a position detection optical system can be accurately detected. Also, the detection light illuminates on the street line and a region different from a region of forming a mark and is not dispersed by any marks, so a sufficient amount of light is obtained for focus detection, which results in improving accuracy in detecting position deviation.

Furthermore, according to the present invention, since the first detection light and the second detection light perpendicularly crossing each other can be irradiated on the street line on which a mark is formed, it is preferable to detect a position of the mark. Also, if a plurality of at least one of the first detection lights and the second detection lights are provided (if the number of illumination (illumination positions) of the illumination light on the street line is increased), position deviation at a plurality of positions on the street lines around the mark can be detected by one-time position detection, so it brings an effect that more accurate measurement results can be obtained based on the measurement results on the plurality of positions.

Furthermore, intensities of the reflection lights of the first and second detection lights are compared and focus detection is performed by selecting one of the first or second detection systems in accordance with the comparison results, and by selecting the first detection system when the street line on which the mark for position detection exists is along with the first direction while selecting the second detection system when along with the second direction for performing focus detection, so it is necessary to perform focus detection using a reflection light of a detection light irradiated on regions other than the street lines. As a result, there is an effect of contributing to an improvement of throughput.

Also, according to the present invention, since position deviation of the street line with respect to the focused surface of an alignment apparatus is detected with high accuracy by an alignment apparatus, and alignment of a substrate can be performed with high accuracy based on the highly accurate detection results, there is an effect that it is extremely preferable in a case where producing a finer device is desired.

The present disclosure relates to subject matter contained in Japanese Patent Application No. 2000-069722, filed on Mar. 14, 2000, the disclosure of which is expressly incorporated herein by reference in its entirety.

1. An alignment apparatus, comprising:
a position detection optical system which detects a position of a mark formed on a street line of a substrate; and
a focus detection system which irradiates a detection light to the substrate, and which detects deviation between an irradiated region and a focused surface of the position detection optical system by detecting a reflected light of the detection light, the detection light is irradiated on a region of said street line on which is different from a region formed said mark.

2. The alignment apparatus as set forth in claim 1, wherein:
said street line exists in a first direction and in a second direction perpendicularly crossing with the first direction; and
said focus detection system comprises a first detection system using a first detection light extending along with said first direction and a second detection system using a second detection light extending along with said second direction.

3. The alignment apparatus as set forth in claim 2, wherein at least one of said first and second detection systems detects a plurality of portions on said street lines.

4. The alignment apparatus as set forth in claim 2, wherein said focus detection system makes a comparison of intensities of reflection lights of said first and second detection lights, and performs focus detection by using either one of said first or second detection system in accordance with the comparison result.

5. The alignment apparatus as set forth in claim 2, wherein said focus detection system performs focus detection by using said first detection system when a street line on which a mark for position detection exists is along said first direction, and using said second detection system when the street line is along said second direction.

6. An exposure apparatus wherein a predetermined pattern is exposed to be transferred onto a substrate which is aligned by the alignment apparatus as set forth in claim 1.

7. An alignment method for aligning a substrate on which a mark is formed on a street line, including the steps of:
irradiating a detection light on a region on said street line before detecting a position of the mark by a position detection optical system, the region is different from a region ford said mark;
detecting deviation between an irradiated region and a focused surface of said position detection optical system by detecting a reflected light of the detection light.

8. The alignment method as set forth in claim 7, wherein:
said street line exists in a first direction and a second direction perpendicularly crossing with the first direction; and
a first detection light extending along with said first direction and a second detection light extending along with said second direction are irradiated as said detection lights.

9. The alignment method as sat forth in claim 8, wherein intensities of reflection lights of said first and second detection lights are compared and focus detection is performed by using either one of said first and second detection lights in accordance with the comparison result.

10. The alignment method as set forth in claim 8, wherein focus detection is performed by using said first detection light when a street line on which a mark for position detection exists is along said first direction, and using second detection light when the street line is along said second direction.

11. An exposure method, including the steps of:
aligning a photosensitive substrate as an object to be exposed by using the alignment method as set forth in claim 7; and
exposing the aligned photosensitive substrate with a pattern formed on a mask.
